(19) United States
(12) Patent Application Publication
(10) Pub. No.: US 2009/0157576 A1
(43) Pub. Date: Jun. 18, 2009

(54) MEASURING AND LIMITING DISTRACTIONS ON COMPUTER DISPLAYS

(76) Inventors: Malcolm Slaney, Sunnyvale, CA (US); Srinivasan H. Sengamedu, Bangalore (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/958,183

(22) Filed: Dec. 17, 2007

(51) Int. Cl. G06E 1/00

(52) U.S. Cl. 706/16

(57) ABSTRACT

Techniques are described herein for determining a distractibility measure for an item to be displayed on a display. The distractibility measure for an item is determined based on the individual distractibility measures for one or more of: the static distraction of the item, the onset response of the item, the optic-flow motion of the item, and the change in velocity of objects in the item. Each individual distractibility measure can be further multiplied by a weighting factor which affects the composition of the distractibility measure for the item. The distractibility measure for the item can be further based on the size of the item, how far away the item is from a primary content on the display, and the distractibility measure of the primary content on the display. The distractibility measure for the item can be compared to a maximum level of distractibility for automatically determining whether the item should be displayed on the display. Finally, the techniques described herein can be combined with other techniques which detect specific types of visual content in an item.

### FIELD OF THE INVENTION

The present invention relates to visual items on a computer display and, more specifically, to calculating a measure of distractibility for visual items on a computer display.

### BACKGROUND

Web pages often display advertisements alongside primary content. Such advertisements are visual items, which may be static or dynamic. Dynamic items are visual images on a display that change over time, such as movies and other forms of animated images. Allowing advertisers to place advertisements, or ads, on a web page for a fee is an important mechanism for generating revenue for web page owners. Ads in web pages are often placed near the web page's peripheries so that readers who access the web pages to interact with the primary content on the web pages have unimpeded access to the primary content of the web page. In order to grab the attention of web page readers, advertisers often design ads to distract the reader away from the primary content to the ads.

Web page owners, however, wish to control the degree to which readers are distracted by ads on web pages. If readers of a web page are so distracted by the ads on that web page that they are no longer able to comfortably view the web page's primary content, they are more likely to stop accessing the web page. As a result, the web page owner potentially loses both readership and future advertising revenues.

One approach to control the amount of distractions present in ads is for human reviewers to manually view each and every ad that is submitted before accepting the ad for posting to a web page. In this process, the human reviewer visually determines how distracting a particular ad is and, if the particular ad is deemed to be too distracting, the human reviewer rejects the ad. A drawback to this approach is the tremendous amount of time and effort that must be expended to analyze every ad submitted to an owner's web pages to determine whether the ad is too distracting to be acceptable. Another drawback is the latency in making such determinations. While a submitted ad is waiting for approval from a human reviewer, the relevance of the ad may already have expired. Finally, human judgment is inherently subjective.

Advertising is merely one context in which it is important to measure the degree of distraction of visual items on a computer display. For example, the owners of web pages that display visual items from numerous sources may not want to allow the visual item from one source to be significantly more distracting than the visual items from other sources. As another example, designers of the user interface controls for a game may want to ensure that the visual components of the user interface are not so distracting as to reduce a game player's enjoyment. As yet another example, a web page designer may actually want to maximize the distraction factor of a web page, or of a particular item on the web page.

Therefore, it is desirable to provide an automated mechanism for measuring the distractibility of visual items and for automatically determining whether visual items should be included on a computer-generated display, such as a web page.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram that illustrates an example of a display of a web page that contains a primary display item and several advertisement items.

FIG. 2 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview

Techniques are discussed herein for automatically generating a distractibility measure for visual items. The visual items may be static or dynamic. According to one technique, the distractibility measure is a composite measure based on one or more of the following characteristics in visual items: static distraction, onset response, optic-flow motion, and change in velocity of an element. Static distraction measures how distracting the static elements of a particular visual item is. Onset response measures how much instantaneous changes of the visual item. Optic-flow motion measures a low-level perception of the motion of elements within a visual item. Change in velocity of an element measures how much the velocity of an element within a visual item has changed. Each characteristic used to calculate the composite distractibility measure may be given a different weighting factor. Furthermore, the weighting factors may be extracted from empirical tests conducted with human reviewers.

According to another technique, the distractibility measure for a visual item may further depend on the position of the visual item relative to a primary visual item of a display.

According to another technique, the distractibility measure for a visual item may further depend on the size of the visual item relative to the size of a primary visual item of a display.

According to yet another technique, the distractibility measure for a visual item is determined relative to the distractibility measure of the primary visual item of a display. In this technique, the more distracting the primary visual item, the greater the allowance for the distractibility for the visual item.

According to one technique, the distractibility measure for a particular visual item is compared to a preset maximum distractibility level for determining whether the visual item should be accepted or rejected. If the distractibility measure of the visual item is below the maximum distractibility level, the visual item is accepted for display; otherwise the visual item is rejected.

According to another technique, the preset maximum distractibility level is applied to the entire display, which may contain multiple visual items. A visual item is accepted if the total amount of distractibility from all visual items on the display does not exceed the maximum distractibility level.

The descriptions and examples contained herein are based on one embodiment where the display is a web page, the primary visual item on the display is the primary content of the web page, and the other visual items on the display are advertisements. However, the techniques described herein can also be applied to displays other than web pages, such as digital displays of maps and information in a non-web context. Therefore, the techniques described herein should not be construed to be applicable only to web pages and web page advertisements.

### Automatically Calculating a Measure of Distractibility

A measure of distractibility is calculated for a visual item to be displayed on a screen. The visual item may be in the format of an animated GIF file, a FLASH movie, or any other format for storing static or dynamic visual items. According to one embodiment, the measure of distractibility is calculated from the following equation:

D=a*S+b*O+c*M+d*C

In the above equation, D represents a total measure of distractibility that is a composite of individual distractibility measures S, O, M, and C. S is a measure of static distraction, O is a measure of onset response, M is a measure of optic flow response, and C is a measure of the change in velocity of an object in the display item. Each of these individual distractibility measures are described in more detail below. Furthermore, the individual distractibility measures S, O, M, and C are each multiplied by weighting factors a, b, c, and d, respectively. The weighting factors influence how much weight each individual distractibility measure has in determining the total distractibility measure D. The process of determining weighting factors a, b, c, and d is also described in further detail below.

Although the equation above shows that total distractibility measure D is a composite of four individual distractibility measure S, O, M, and C, it is not required that all four individual distractibility measures be included in calculating D. In alternative embodiments, one or more of the four individual distractibility measures are used to calculate total distractibility measure D. For example, according to one embodiment, total distractibility measure D is calculated based on the following equation:

D=a*S+b*O

In this embodiment, total distractibility measure D is based only on the measure of static distraction S and the measure of onset response O, each weighted by their respective weighting factors.

The distractibility measures S, O, M, and C may be measured in two ways. According to one embodiment, the code that generates the visual item, which contains information about each graphical object in the visual item and how the graphical objects move and change over time, is analyzed to determine S, O, M, and C. According to another embodiment, computer-vision techniques are employed to determine the distractibility measures. These techniques are described in further detail below.

Static Distraction. Static distraction (S) measures how distracting the static portion of an item displayed on a screen is. For example, a high contrast of color, such as a red figure on a white backdrop, results in more static distraction. In the simplest embodiment, the static distraction is equal to the average pixel-by-pixel difference of the image from the average color of the overall display. This measures the degree of non-conformity of the displayed ad. A more sophisticated, and thus more accurate approach is proposed in Itti, L. and Koch, C., “A saliency-based search mechanism for overt and covert shifts of visual attention,” Vision Research, Vol. 40, pp. 1489-1506, 2000.

Onset Response. Onset response (O) measures how much change there is between one image and a next image in a displayed item. Thus, onset response is applicable only to visual items which are dynamic and change over time. For example, a blinking text contains onset response because the visual item continually changes from blank text to filled text and back to blank text again. In one embodiment, onset response is measured on a pixel-by-pixel basis by calculating the difference in intensity between a pixel in a first frame of a dynamic visual item and the corresponding pixel in a second frame of the dynamic visual item. The more change in pixel intensity from one frame to the next in a visual item, the higher the onset response and the more distracting the visual item.

Optic Flow Motion. Optic flow motion (M) measures a low-level perception of the motion of elements within a displayed visual item. Thus, optic flow motion is also applicable only to visual items which are dynamic and change over time. Algorithms for measuring optical flow motion do so by estimating the deformations between two visual item frames, using the basic assumption that the intensity or color of elements in the visual item has not changed significantly between the two visual item frames. M is the average of the magnitude of the pixel-by-pixel optic flow results. According to an embodiment, the measure of optic flow motion is calculated using the Lucas-Kanade method as described in Lucas, B. D., and Kanade, T., “An iterative image registration technique with an application to stereo vision,” Proceedings of Imaging Understanding Workshop, pp. 121-130, 1981. In a more sophisticated approach, the estimate of M can also be scaled by the overage salience (from the calculation of S) so that hard-to-see motion is downplayed.

Change in Velocity of an Element. Change in velocity of an element (C) measures how much the velocity of an element within a visual item changes. This measure is also applicable only to visual items which are dynamic and change over time. C is the average of the magnitude of the pixel-by-pixel change in velocity for each object. Almost any visual item is composed of a few distinct elements, or objects, and a background. The first step in measuring the change in velocity of an object in a visual item is to recognize, or detect, the object in the visual item. The velocity of each point in the object may then be determined using techniques for optic-flow measurement. According to one embodiment, object detection is performed using the approach described in Ben-Ezra, Moshe, and Peleg, Shmuel, “Motion Segmentation Using Convergence Properties,” Institute of Computer Science, The Hebrew University of Jerusalem, Proceedings of Image Understanding Workshop, Vol. II, pp. 1233-1235, 1994. The change in velocity for an object is then determined by subtracting the velocity of the object in one frame in a dynamic visual item the velocity of the object in a subsequent frame in the dynamic visual item. Alternatively, objects in a visual item may be detected by performing k-means clustering on a joint vector consisting of the position and the scaled velocity of each non-zero optic-flow measurement. Once objects are segmented and velocity estimates are obtained, the change in velocity of each objected may be calculated.

In a more sophisticated approach, the estimate of C can also be scaled by the overage salience (from the calculation of S) so that hard-to-see motion is downplayed. In another embodiment, a simpler calculation for C is performed where object boundaries are ignored and C is calculated from the change in velocity at each pixel.

Determination of Weighting Factors. According to one embodiment, the weighting factors a, b, c, and d are determined empirically through testing of human reviewers. For example, a web page designed for testing may display as its primary content a game that requires visual concentration to play. The test web page may further display an advertisement in the side margins of the web page, for which each of the individual distractibility measures are calculated. Human reviewers are then asked to play the game, and regression analyses are performed to determine how an advertisement's individual distractibility measures influences the human reviewers' score. A higher score in the game correlates with a smaller distractibility measure. Therefore, by analyzing how scores correlate with the individual distractibility measures, appropriate weights may be assigned to accurately reflect how of the four individual distractibility measures S, O, M, and C contribute to the overall distractibility measure of an item. Different types of items which emphasize different individual distractibility measures may be displayed as part of the testing process. Also, the human reviewers may be asked to perform tasks other than playing games, such as reading a text passage and taking a test based on the text passage.

### Additional Factors Used in Calculating a Measure of Distractibility

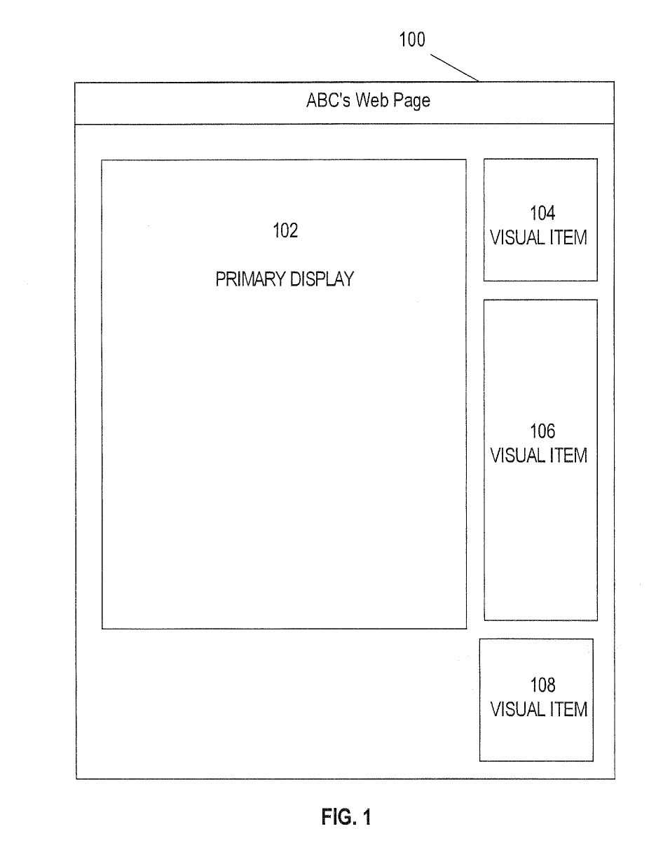

Distance from primary visual item. The discussion above focused on calculating a total distractibility measure D based on one or more of the four individual distractibility measures S, O, M, and C, where an individual distractibility measure may in turn be multiplied by a weighting factor. According to one embodiment, the total distractibility measure D for a visual item may be further based on the position of the visual item on the display relative to the position of a primary visual item on the display. Because humans are distracted differently by visual items which are in their peripheral vision than by visual items which are in their central field of vision, the farther away the visual item is from the primary content on the display, the less distracting the visual item is. For example, FIG. 1 illustrates a webpage 100 which is displayed. Webpage 100 contains primary display 102 and peripheral visual items 104, 106, and 108. In this example, visual items 104 and 108 are the same size. However, visual item 108 is further away from the primary display than visual item 104. Therefore, if visual items 108 and 104 contained the same visual item content, visual item 108 is less distracting to a human viewer than 104.

In one embodiment, a final distractibility measure for a visual item is determined by multiplying the total distractibility measure of the visual item with a factor that accounts for the distance of the visual item relative to the primary visual item on the display. This multiplication factor can be based on the actual distance between the visual item and the primary visual item. Alternatively, the multiplying factor can be based on a difference between the viewing angle from a human viewer's eyes to the primary content and the viewing angle from a human viewer's eyes to the visual item. The multiplication factor may be determined by conducting tests and analyzing the test results as described above for determining the weighting factors for individual distractibility measures S, O, M, and C.

Size relative to primary visual item. According to one embodiment, a final distractibility measure for a visual item is determined by multiplying the total distractibility measure of the visual item with a factor that accounts for how big the item is relative to the primary visual item on the display. The bigger the visual item is relative to the primary visual item, the more distracting the visual item is. For example, in FIG. 1, where area 102 represents the primary visual item on web page 100, peripheral visual item 106 is more distracting than peripheral visual item 104 because it is bigger than peripheral visual item 104 (assuming that the total distractibility measures for peripheral visual items 104 and 106 are equal). Therefore, in one embodiment, the final distractibility measure is determined by multiplying the total distractibility measure with a size factor. The multiplication factor may be determined by conducting tests and analyzing the test results as described above for determining the weighting factors for individual distractibility measures S, O, M, and C.

Relative distractibility. According to another embodiment, total distractibility measures are calculated for both a visual item and the primary visual item on the display. When the primary visual item's total distractibility measure is high, the primary visual item is better at grabbing the viewer's attention, resulting in the viewer being less distracted by peripheral visual item. For example, if the primary visual item is a movie trailer that contains a lot of fast-moving action scenes, the viewer is less likely to be distracted by a peripheral visual item that contains blinking text. However, if the primary visual item contains static text, then the viewer is more likely to be distracted by the same peripheral visual item containing blinking text. Therefore, in one embodiment, the final distractibility measure of a peripheral item is determined by subtracting from the total distractibility measure of the peripheral item scaled by a factor that accounts for the relative total distractibility measures of the primary visual item and the peripheral visual item. The scaling factor may be determined by conducting tests and analyzing the test results as described above for determining the weighting factors for individual distractibility measures S, O, M, and C.

Although these techniques have been individually described, they may also be used in any combination for determining a distractibility measure.

### Setting and Enforcing a Maximum Level of Distractibility

According to one embodiment, a maximum allowable level of distractibility for a visual item to be displayed is set by the owner of the display. For example, if the display is a web page, the owner of the web page may wish to limit the amount of distractibility in advertisements displayed on the web page in order to ensure that readers of the web page are not discouraged from viewing the primary content of the web page. In this embodiment, a final distractibility measure is determined for any advertisement that is submitted for display on the web page and the final distractibility measure for the advertisement is then compared to the preset maximum level of distractibility. If the final distractibility measure does not exceed the preset maximum level of distractibility, the advertisement is automatically accepted for display; otherwise, the advertisement is automatically rejected for display. Significantly, once the maximum allowable level of distractibility has been set, no human intervention is needed to process submitted advertisements to ensure that the advertisements are not excessively distracting.

According to another embodiment, a maximum total allowable level of distractibility is set by the owner of the display for all visual items displayed on a display. For example, if the display is a web page, the owner of the web page may wish to limit the total amount of distractibility in advertisements displayed on the web page in order to ensure that readers of the web page are not discouraged from viewing the primary content of the web page. In this embodiment, an advertisement is accepted only if the sum of its distractibility measure and the distractibility measures of other advertisements to be displayed on a web page does not exceed the total allowable level of distractibility. Setting a maximum level of total allowable distractibility provides increased flexibility for accepting ads with varying distractibility measures while maintaining a ceiling on the total distractibility from advertisements on a particular web page.

### Other Uses of the Distractibility Measure

Decisions about whether or not to include a visual item on a display is merely one use of a distractibility measure. There is virtually no limit to the ways distractibility measures may be used. For example, the distractibility measures of items on a display may be used as a factor in deciding where, within the display, the items are displayed. As another example, the distractibility measure may be used as a basis for determining how much a web page owner charges an advertiser for placement of an ad—the more distracting, the higher the ad placement cost. As yet another example, the distractibility measures may be used to ensure that the visual displays generated by programs designed for special needs children are not too distracting.

### Additional Mechanisms for Determining Whether an Item Should be Displayed

The techniques described herein can be used alone or in conjunction with other mechanisms that detect particular kinds of content in order to determine whether an item should be displayed. One such mechanism, a mechanism for detecting particular body parts in a digital image, is disclosed and described in U.S. patent application Ser. No. 11/715,155 (Attorney Docket Number 50269-0829), titled “Part-Based Pornography Detection”, filed on Mar. 6, 2007 by Sengamedu. For example, an owner of a web page may reject an advertisement if the advertisement's distractibility measure exceeds a maximum distractibility level or if particular body parts are detected in the advertisement.

### Hardware Overview

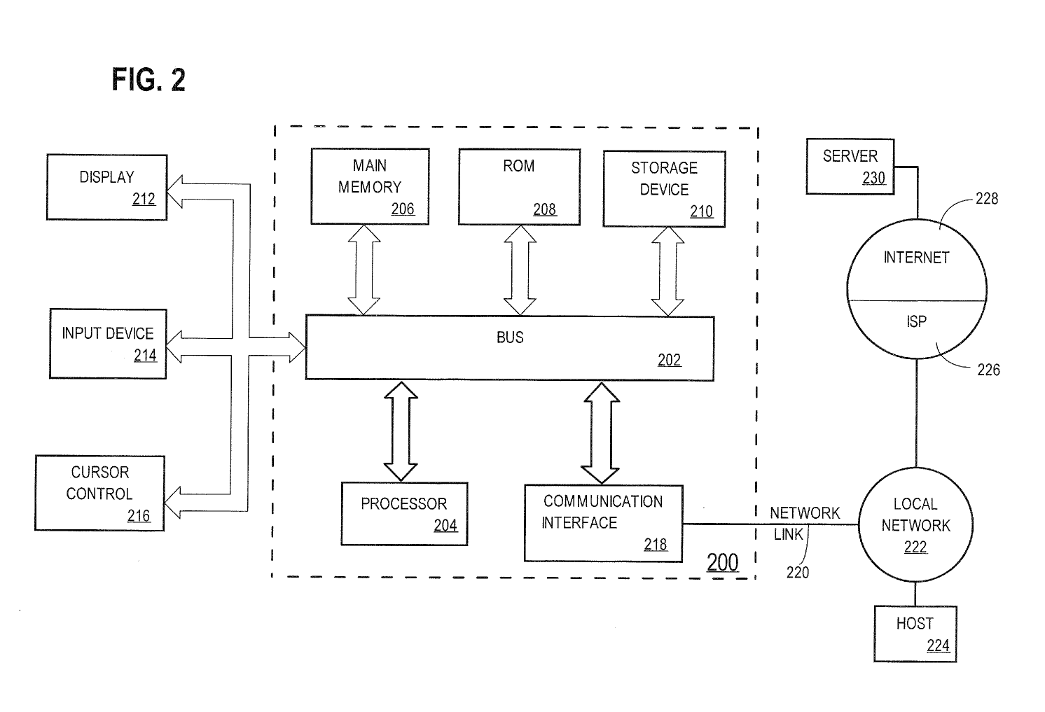

FIG. 2 is a block diagram that illustrates a computer system 200 upon which an embodiment of the invention may be implemented. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

The invention is related to the use of computer system 200 for implementing the techniques described herein. According to one embodiment of the invention, those techniques are performed by computer system 200 in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 200, various machine-readable media are involved, for example, in providing instructions to processor 204 for execution. Such a medium may take many forms, including but not limited to storage media and transmission media. Storage media includes both non-volatile media and volatile media. Non-volatile media includes, for example, optical or magnetic disks, such as storage device 210. Volatile media includes dynamic memory, such as main memory 206. Transmission media includes coaxial cables, copper wire and fiber optics, including the wires that comprise bus 202. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 204 for execution. For example, the instructions may initially be carried on a magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are exemplary forms of carrier waves transporting the information.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution. In this manner, computer system 200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for automatically generating a distractibility measure for an item to be displayed on a display, the method comprising the computer-implemented steps of:
for each characteristic of one or more characteristics of a set of characteristics of the item, determining a characteristic-based distractibility measure;
wherein the set of characteristics consists of static imagery, onset response, optic-flow motion, and change in velocity; and
generating and storing in a computer-readable medium the distractibility measure for the item, wherein the distractibility measure for the item is based at least in part on the characteristic-based distractibility measures of the one or more characteristics of the set of characteristics of the item.

2. The method of claim 1, wherein the step of generating the distractibility measure for the item comprises:
for the each characteristic of the one or more characteristics of the set of characteristics of the item, generating a weighted characteristic-based distractibility measure by multiplying the characteristic-based distractibility measure for the each characteristic with a weight associated with the each characteristic; and
generating the distractibility measure for the item by summing the weighted characteristic-based distractibility measures for the each characteristic of the one or more characteristics of the set of characteristics of the item.

3. The method of claim 1, wherein the distractibility measure for the item is based at least in part on a distance on the display between a primary item and a location for displaying the item.

4. The method of claim 1, wherein the distractibility measure for the item is based at least in part on a size on the display of a primary item and a size of the item.

5. A method for automatically determining whether an item should be displayed on a display, comprising the computer-implemented steps of:
generating a distractibility measure for the item;
comparing the distractibility measure to a threshold value indicating a maximum distractibility measure; and
in response to determining that the distractibility measure for the item is less than the threshold value, determining that the item should be displayed on the display.

6. A method for automatically determining whether an item should be displayed on a display, comprising the computer-implemented steps of:
generating a distractibility measure for the item;
generating a primary distractibility measure for a primary item, wherein the primary item is to be displayed on the display;
based on the primary distractibility measure and the distractibility measure for the item, determining whether the item should be displayed on the display; and
storing in a computer-readable medium an indication of whether the item should be displayed on the display.

7. The method of claim 6, wherein the step of determining whether the item should be displayed on the display is further based on a preset threshold ratio value.

8. The method of claim 6, wherein the step of determining whether the item should be displayed on the display comprises:
determining a ratio between the primary distractibility measure and the distractibility measure;
comparing the ratio to a threshold value indicating a maximum ratio of distractibility; and
in response to determining that the ratio is less than the maximum ratio of distractibility, determining that the item should be displayed on the display.

9. A method for automatically determining whether an item should be displayed on a display, comprising the computer-implemented steps of:
generating a distractibility measure for the item;
for each other item of one or more items which are to be displayed on the display, generating a distractibility measure for the each other item;
generating a total distractibility measure by summing the distractibility measure for the item and the distractibility measures for the each other item of the one or more items which are to be displayed on the display;
based on the total distractibility measure, determining whether the item should be displayed on the display; and
storing in a computer-readable medium an indication of whether the item should be displayed on the display.

10. The method of claim 9, wherein the step of determining whether the item should be displayed on the display further comprises:
comparing the total distractibility measure to a threshold value indicating a maximum total distractibility measure; and
in response to determining that the total distractibility measure for the item is less than the threshold value, determining that the item should be displayed on the display.

11. A computer-readable storage medium storing instructions for automatically generating a distractibility measure for an item to be displayed on a display, the instructions including instructions which, when executed by one or more processors, cause the one or more processors to perform the steps of:
for each characteristic of one or more characteristics of a set of characteristics of the item, determining a characteristic-based distractibility measure;
wherein the set of characteristics consists of static imagery, onset response, optic-flow motion, and change in velocity; and
generating and storing in a computer-readable medium the distractibility measure for the item, wherein the distractibility measure for the item is based at least in part on the characteristic-based distractibility measures of the one or more characteristics of the set of characteristics of the item.

12. The computer-readable storage medium of claim 11, wherein the step of generating the distractibility measure for the item comprises:
for the each characteristic of the one or more characteristics of the set of characteristics of the item, generating a weighted characteristic-based distractibility measure by multiplying the characteristic-based distractibility measure for the each characteristic with a weight associated with the each characteristic; and
generating the distractibility measure for the item by summing the weighted characteristic-based distractibility measures for the each characteristic of the one or more characteristics of the set of characteristics of the item.

13. The computer-readable storage medium of claim 11, wherein the distractibility measure for the item is based at least in part on a distance on the display between a primary item and a location for displaying the item.

14. The computer-readable storage medium of claim 11, wherein the distractibility measure for the item is based at least in part on a size on the display of a primary item and a size of the item.

15. A computer-readable storage medium storing instructions for automatically determining whether an item should be displayed on a display, wherein the instructions include instructions for performing the steps of:
generating a distractibility measure for the item;
comparing the distractibility measure to a threshold value indicating a maximum distractibility measure; and
in response to determining that the distractibility measure for the item is less than the threshold value, determining that the item should be displayed on the display.

16. A computer-readable storage medium storing instructions for automatically determining whether an item should be displayed on a display, the instructions including instructions which, when executed by one or more processors, cause the one or more processors to perform the steps of:
generating a distractibility measure for the item;
generating a primary distractibility measure for a primary item, wherein the primary item is to be displayed on the display;
based on the primary distractibility measure and the distractibility measure for the item, determining whether the item should be displayed on the display; and
storing in a computer-readable medium an indication of whether the item should be displayed on the display.

17. The computer-readable storage medium of claim 16, wherein the step of determining whether the item should be displayed on the display is further based on a preset threshold ratio value.

18. The computer-readable storage medium of claim 16, wherein the step of determining whether the item should be displayed on the display comprises:
determining a ratio between the primary distractibility measure and the distractibility measure;
comparing the ratio to a threshold value indicating a maximum ratio of distractibility; and
in response to determining that the ratio is less than the maximum ratio of distractibility, determining that the item should be displayed on the display.

19. A computer-readable storage medium for automatically determining whether an item should be displayed on a display, comprising the computer-implemented steps of:
generating a distractibility measure for the item;
for each other item of one or more items which are to be displayed on the display, generating a distractibility measure for the each other item;
generating a total distractibility measure by summing the distractibility measure for the item and the distractibility measures for the each other item of the one or more items which are to be displayed on the display;
based on the total distractibility measure, determining whether the item should be displayed on the display; and
storing in a computer-readable medium an indication of whether the item should be displayed on the display.

20. The computer-readable storage medium of claim 19, wherein the step of determining whether the item should be displayed on the display further comprises:
comparing the total distractibility measure to a threshold value indicating a maximum total distractibility measure; and
in response to determining that the total distractibility measure for the item is less than the threshold value, determining that the item should be displayed on the display.
